(19) United States
(12) Patent Application Publication
(10) Pub. No.: US 2008/0094600 A1
(43) Pub. Date: Apr. 24, 2008

(54) ILLUMINATION DEVICE AND MASK FOR MICROLITHOGRAPHY PROJECTION EXPOSURE SYSTEM, AND RELATED METHODS

(75) Inventor: Rolf Freimann, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/875,352

(22) Filed: Oct. 19, 2007

(30) Foreign Application Priority Data
Oct. 20, 2006 (DE) 10 2006 049 612.4

(51) Int. Cl. G03B 27/72; G03B 27/54

(52) U.S. Cl. 355/71; 355/67

(57) ABSTRACT

Illumination devices and masks for microlithography projection exposure systems, as well as related systems and methods, are disclosed.

### CROSS-REFERENCE TO RELATED APPLICATION

This application claims priority to German patent application serial number 10 2006 049 612.4, filed Oct. 20, 2006, which is hereby incorporated by reference.

### FIELD

The disclosure relates to illumination devices and masks for microlithography projection exposure systems, as well as related systems and methods.

### BACKGROUND

Microlithography exposure systems are known in which structures on a mask are imaged onto a semiconductor wafer disposed in a wafer plane. Typically this involves using an illumination device to illuminate the portion of the mask which is to be imaged.

### SUMMARY

The disclosure relates to illumination devices and masks for microlithography projection exposure systems, as well as related systems and methods.

In one aspect, the disclosure features an illumination device having a mask plane. The illumination device includes a radiation source configured to generate electromagnetic radiation, and illumination optics configured to direct the electromagnetic radiation onto the mask plane. The illumination system has a mask plane where the mask, when present, is located. The illumination device is configured to generate an interference pattern in the mask plane. The illumination device is configured to be used in a microlithography projection exposure system.

In a further aspect, the disclosure features a microlithography projection exposure system that has a mask plane and an object plane. The system includes an illumination device (e.g., as described in the preceding paragraph) configured to generate an interference pattern in the mask plane. The system also includes projection optics configured to image at least a portion of the interference pattern from the mask plane into the wafer plane.

In another aspect, the disclosure features a mask that includes at least one mask structure configured to generate a target structure in a radiation sensitive medium. The mask is configured to be used in a microlithography projection illumination system, and the shape of the mask structure differs from the shape of a target structure so that the target structure can be generated in the radiation sensitive medium via illumination of the mask through variable illumination in the mask plane.

In an additional aspect, the disclosure features a method that includes providing a microlithography projection exposure system that has a mask plane and a wafer plane. The system includes an illumination device configured to illuminate the mask plane with electromagnetic radiation, an object in the wafer plane, and projection optics configured to image an object structure from the mask plane into the wafer plane. The method also includes generating an interference pattern in the mask plane via the illumination device, and imaging at least a portion of the interference pattern via the projection optics onto the object

In some embodiments, the disclosure provides a microlithography projection exposure system, a mask for such exposure system, and a method for lithographic exposure of an object, whereby structures with great geometric variety can be generated on the object in an efficient manner, and simultaneously the requirements with respect to the dimensional precision of the mask can be kept moderate.

In certain embodiments, the disclosure provides an illumination device for a microlithography projection exposure system with a radiation source for generating electromagnetic radiation, and illumination optics for directing the electromagnetic radiation onto a mask plane of the microlithography projection exposure system. The illumination device is configured to generate an interference pattern in the mask plane in the state in which the illumination device is mounted in the microlithography projection exposure system. In some embodiments, the disclosure provides a mask for such microlithography projection exposure system. The mask has at least one mask structure for generating a target structure in a radiation sensitive medium, and the shape of the mask structure deviates from the shape of the target structure so that the target structure can be generated in the radiation sensitive medium through illumination of the mask through variable illumination in the mask plane, in particular through an interference pattern, generated through the above mentioned illumination device. In some embodiments, the disclosure provides a microlithography projection exposure system with a mask plane for disposing a mask, a wafer plane for disposing an object to be exposed, in particular a wafer, an illumination device of the above mentioned type for generating an interference pattern in the mask plane, and projection optics for imaging at least a portion of the interference pattern from the mask plane into the wafer plane.

In certain embodiments, the disclosure provides a method for lithographic exposure of an object through a microlithography projection exposure system. The microlithography projection exposure system includes a mask plane, a wafer plane, an illumination device for illuminating the mask plane with electromagnetic radiation, and projection optics for imaging an object structure from the mask plane into the wafer plane. The method includes disposing the object in the wafer plane, generating an interference pattern in the mask plane through the illumination device and imaging at least a portion of the interference pattern onto the object through the projection optics.

Put differently, in certain embodiments, an illumination device for a microlithography projection exposure system is provided, through which a structured exposure or an exposure with varied illumination in the mask plane can be created in the mask plane through interference. The generated interference pattern can be formed in particular as a standing wave. Contrary to many instances of interference lithography, no interference pattern is created in the wafer plane, but created in the mask plane of the microlithography projection exposure system.

When a mask is disposed in the mask plane, portions of the interference pattern can be blanked out through respective mask structures. Compared to the structural dimension of the interference pattern, the desired properties for sizing of the mask structures of such mask are relatively less pronounced. A relatively “coarse” mask is thus irradiated with a very finely structured illumination. The tolerances of the mask structures can thus be increased. Also, the mask structures can be possibly sized larger. Through projection optics, the portions of the interference pattern, which are passed through by the mask, can be imaged into the wafer plane. The desired properties for the mask precision can therefore be reduced. Furthermore, it is also possible to operate the microlithography projection exposure system without a mask, and to image the structures of the interference patterns from the mask plane directly into the wafer plane. In any case, small size interference structures are used to generate an image with small structures in the wafer plane.

This can reduce the efforts associated with creating a mask. Possibly, it can even be omitted to provide an optical reduction through projection optics when imaging the structures from the mask plane into the wafer plane, whereby the manufacturing cost of the projection optics can be reduced. Through the possibility to additionally dispose a mask in the mask plane, and to possibly modify the interference pattern, generated in the mask plane accordingly, a multitude of structures can be generated on the object or the wafer.

In some embodiments, the illumination device is configured to generate at least two single waves, which are coherent to each other, and to generate the interference pattern through superposition of the single waves in the mask plane. The two planar single waves can interfere in the mask plane. This can be achieved, for example, by irradiating into the mask the single waves at an acute angle relative to each other. The two single waves can form identical angles in the mask plane with the optical axis of the projection optics. The single waves can thus symmetrically impact the mask plane.

In certain embodiments, the illumination optics include a single wave generation element (e.g., a beam splitter) and at least one reflection element. During the operation of the illumination device the single wave generation element splits the electromagnetic radiation into the two single waves and the reflection element redirects one of the two single waves, so that the two single waves generate the interference pattern through superposition in the mask plane. It can be advantageous, when the single wave generation element is provided as a beam splitter, through which the arriving electromagnetic radiation is split into two single waves with different propagation directions. Through the at least one reflection element, the single waves are then joined again in the mask plane. Alternatively, the single wave generation element can also be provided in the form of a beam expansion element and can serve the purpose of expanding the electromagnetic radiation generated by the radiation source into a beam with expanded diameter. This beam with expanded diameter then includes single waves. The reflection element in this case is used for redirecting a portion of the expanded beam, this means, one of its single waves, so that it interferes with another portion of the expanded beam, this means, with another single wave of the beam in the mask plane. For this purpose, for example, also a so-called corner-cube arrangement can be selected, in which the reflection element is disposed at a side surface of the corner-cube, and the mask plane is disposed at another side surface of the corner-cube.

Furthermore, it can be advantageous, when the illumination device is configured to displace the interference pattern through changing the relative phase of the single waves of the interference pattern from a first position into a second position in the mask plane. Thus, the interference pattern is displaced transversal to the optical axis of projection optics of an associated microlithography projection exposure system. In some embodiments, the illumination system for multiple exposure of at least one portion of an object through the microlithography projection exposure system is configured to generate the interference pattern in the first position during a first exposure and to generate the interference pattern in the second position during a second exposure. Furthermore, it can be advantageous for the interference pattern to include periodically occurring intensity maxima, and for the first position of the interference pattern to be displaced relative to the second position of the interference pattern by at least one quarter period (e.g., by a half period of the interference pattern in the mask plane). Through displacing the interference pattern through changing the relative phase of the single waves, it is possible to overcome the limited resolution of the projection optics, defined by the wave length of the electromagnetic radiation, through multiple exposures of an object or a wafer. After a first exposure of the object with the interference pattern in the first position, thereafter a second exposure of the interference pattern in the second position can be performed. Thus, structures are written between structures generated already in the first exposure. It is also possible to perform a multiple exposure of the object through at least one mask. Thus, illuminated structures of the mask are imaged onto the object in a first exposure through the interference pattern disposed in the first position and in the second exposure structures of the mask illuminated through the interference pattern disposed in the second position are projected onto the object.

Furthermore, it can be advantageous, when the reflection element is movable, so that the relative phase of the single waves can be changed through moving the reflection element, wherein in particular, the moving direction in assembled state of the illumination device is aligned in parallel with the mask plane. In particular, the movement direction of the reflection element is aligned transversal to the optical axis of the projection optics of the associated microlithography projection exposure system. Such a movable reflection element allows a change of the relative phase of the single waves in a particularly precise and simple manner.

Furthermore, it can be advantageous, when the single wave generation element is provided as a diffractive beam splitter, and movable to change the relative phase of the single waves, in particular movable transversal to the mask plane. Such a diffractive beam splitter can e.g. include a linear grid. The partial beams created by the grid in opposite diffraction order are then superimposed for generating the interference pattern. Such diffractive beam splitter can have the advantage that the irradiation strength pattern generated by the beam splitter is approximately independent of the wave length of the incoming light. Furthermore, the required relative phase movement can be accomplished in a simple manner through moving the beam splitter perpendicular to the optical axis.

In certain embodiments, the illumination optics include at least one aperture to define an illuminated area in the mask plane, wherein the aperture is disposed in the beam path of the illumination optics in front of the single wave generation element. Furthermore, it can be advantageous when a lens is disposed between the aperture and the single wave generation element, through which the aperture is imaged into the plane of the single wave generation element. The at least one aperture can be provided as a variable aperture and it is used for adjusting the size of the image field generated on the object during the exposure step. Through imaging the aperture into the plane of the single wave generation element or the beam splitter through the lens the requirements with respect to the imaging precision of the lens are kept moderate. In case the aperture is imaged into the mask plane, it is complicated to image the interference pattern optically with little distortion.

Furthermore, it can be advantageous, when the illumination device is configured to operate in a microlithography projection exposure system configured as a scanner, in which the exposed object, in particular, a wafer, is continually moved in a wafer plane of the microlithography projection exposure system during exposure, wherein the illumination device is furthermore configured to move the interference pattern during the illumination of the object in the mask plane, so that the image of the interference pattern in the wafer plane follows the motion of the object. In such a microlithography projection exposure system configured as a scanner, an illumination slot or a scanner slot is moved over the object for illuminating a field on the object. The field on the object is thus continually “written” through moving the illumination slot relative to the object. In conventional microlithography projection exposure systems, the mask is moved in the mask plane together with the movement of the object or the wafer, so that the image of the mask in the wafer plane follows the movement of the object. However, the interference pattern constitutes at least a portion of the structures to be imaged onto the object. Therefore, the interference pattern in the mask plane can be displaced so that its image in the wafer plane follows the movement of the object. Thus, the interference pattern is moved transversal to the optical axis of the projection optics. In some embodiments, the movement is performed through changing the relative phase of the single waves generating the interference pattern. Alternatively, also the illumination device can be moved relative to the projection optics of the microlithography projection exposure system.

It can be advantageous for the interference pattern generated by the illumination device to have a stripe pattern with straight stripes, which are disposed periodically and wherein the rims of the stripe pattern extend along a straight line respectively, wherein the maximum deviation of the rims from the respective straight line amounts to less than one twentieth of the stripe period. Thereby, it can be assured that the distortion of the stripes of the interference pattern is so small that the single printed structures do not run into each other during a double exposure with interference patterns displaced by a half stripe period. At an exemplary illumination wave length of 193 nm and a stripe period of approximately 100 nm, the stripe distortion can thus only be in the nm range, in order for the stripe distortion of the stripes printed onto the object through the double exposure to amount to less than one tenth of the stripe distance from the object. For this purpose, the incoming planar wave in this section has to be flat and the single wave generation element and a possible additional optical component also have to comply with this specification.

In order to increase the geometric variety of the structures, which can be imaged onto the object, it can be advantageous for the illumination device to be configured to generate the interference pattern in different orientations, in particular in orientations perpendicular to each other, in the mask plane. Thus, structures with different orientations can be imaged onto the object with several exposures or exposure steps. Furthermore, it is possible during the use of an additional mask to selectively illuminate differently oriented structures on the mask. Thus for example, only horizontally disposed lines can be illuminated on the mask in a first illumination step, and in a second illumination step, vertically oriented lines can be illuminated on the mask.

In certain embodiments, the microlithography projection exposure system is configured to expose at least one portion of the object, in particular of the wafer, multiple times, wherein in a first exposure, the interference pattern is disposed in a first position in the mask plane, and in a second exposure, the interference pattern is disposed in a second position, offset relative to the first position in the mask plane. Thus, a double exposure of the object can be performed, through which the printable line frequency can be doubled, as described above. In order to move the interference pattern from the first position into the second position, as already described before also, for example, the relative phase of the single waves can be changed, or also the illumination device and the projection optical system can be moved relative to each other.

Furthermore it can be advantageous for the interference pattern to provide periodically occurring intensity maxima and the first position of the interference pattern, is offset relative to the second position of the interference pattern by at least one quarter period (e.g., by half a period of the interference pattern in the mask plane). In this case, the structures generated through the interference pattern, disposed in the second position, can be printed on the object between the structures generated during a first exposure through the interference pattern disposed in the first position. Thus, the stripe frequency relative to a single exposure can be doubled.

In certain embodiments, the projection optics are configured for operation with electromagnetic radiation in a certain wave length range, thereby including a resolution limit for imaging an even stripe pattern from the mask plane into the wafer plane, wherein a minimum distance between neighboring stripes of a stripe pattern, which can still be imaged by the projection optics, is defined through the resolution limit, and wherein the first position of the interference pattern is offset relative to the second position of the interference pattern by less than the minimum distance, in particular, by half the minimum distance in the mask plane. The resolution limit of projection optics is generally proportional to a ratio of the illumination wave length and the numerical aperture of the projection optics. The stripe frequency of a stripe pattern, which can be printed at the resolution limit onto the object with projection optics, can be doubled, when the first position of the interference pattern is offset relative to the second position by less than the minimum distance (e.g., by half the minimum distance in the mask plane). In this case, it is possible, to project a stripe pattern with a still printable stripe distance onto the object, through the first exposure, and thereafter project a stripe pattern with a similar stripe period through the second exposure, between the stripe pattern printed through the first exposure.

Furthermore, it can be advantageous for the projection optical system to have an optical axis, and for the illumination device and the projection optics to be movable relative to each other in a direction transverse to the optical axis. Thus in particular the interference pattern in the mask plane can be moved from the first position into the second position for performing a double exposure. Furthermore, the movable support can be used to move the interference pattern in the mask plane during the scanner motion, when the microlithography projection exposure system is configured as a scanner, as will be subsequently described in more detail.

Furthermore, it can be advantageous for the microlithography projection exposure system to be configured as a scanner and to have a moving platform for the object, which will subsequently be designated as wafer stage, for continuous movement of the object in the wafer plane during exposure, wherein the microlithography projection exposure system is furthermore configured to move the interference pattern in the mask plane during the exposure of the object, so that the image of the interference pattern in the wafer plane follows the movement of the object. As already described previously, the movement of the interference pattern can be performed through changing the relative phase of the single waves generating the interference pattern, or also through a movement of the illumination device and the projection optics relative to each other. This function of a scanner has already been described previously. The interference pattern is continuously moved according to this embodiment during the exposure in the mask plane, so that its projection in the wafer plane during the exposure of a field on the object or the wafer is moved with the movement of the wafer stage.

Furthermore, it can be advantageous, when the microlithography projection exposure system has a moving platform for the mask, which is subsequently designated as reticle stage for continuous movement of the mask in the mask plane with a movement coupled to the movement of the wafer stage, wherein the illumination device is configured to move the interference pattern in the mask plane synchronous with the movement of the reticle stage, while the object is exposed. The reticle stage moves depending on the movement of the wafer stage, and on the reduction factor of the projection optics (e.g., opposite to the movement direction of the wafer stage). At a reduction factor of e.g. four, the reticle stage moves four times as fast as the wafer stage. In any case, the movement of the reticle stage is adjusted to the movement of the wafer stage, so that the image of a mask mounted onto the reticle stage, projected into the wafer plane, moves with an object located on the wafer stage. Since at least a portion of the interference pattern characterizes a structure to be imaged onto the object, it can be advantageous for the interference pattern to be moved with the reticle stage during exposure. Alternatively, the microlithography projection exposure system can be configured as a stepper in which the exposure of a field on a wafer is performed in a static manner. In this case, a movement of the interference pattern in the mask plane during an exposure of the object is not required.

Furthermore, it can be advantageous for the microlithography projection exposure system to include a mask disposed in the mask plane with at least two mask structures offset from each other. Optionally, the two mask structures are provided line shaped and extend in parallel to each other. One of the two mask structures can be illuminated through the interference pattern, while the other mask structure thereby remains not illuminated. Furthermore it can be advantageous, when the distance between the two mask structures is adjusted to the interference pattern, so that in the first position of the interference pattern an intensity maximum of the interference pattern falls onto the first mask structure and an intensity minimum of the interference pattern falls onto a second mask structure and in the second position of the interference pattern, the intensity maximum falls onto the second mask structure, and the intensity minimum falls onto the first mask structure. Thus, as already described above, only the first mask structure can be imaged through a first exposure of an object, and during a second exposure of an object, the second mask structure can be printed at an offset from the first mask structure, which cannot be achieved through a single exposure.

In some embodiments, an object, in particular a wafer, is disposed in the wafer plane, which is coated with a two photon resist. Such two photon resist includes molecules, whose energy levels are adapted to be excited through the absorption of two irradiated photons of the illumination wave length. When imaging an interference pattern with an intensity distribution in sin²(x)-form, depending on a coordinate x in the wafer plane, the radiation intensity absorbed by the two photon resist has a sin⁴(x)-, or a cos⁴(x)-distribution. To the contrary, the radiation intensity absorbed by a conventional one photon resist has a sin²(x)- or cos²(x)-distribution. When using a one photon resist and a double exposure of the object with an interference pattern in sin²(x)-distribution moved by half a period, the absorbed intensity adds up to a value, which is constant along the location coordinate. In this case, a sin²(x)-intensity distribution is absorbed in the resist during a first exposure, and during a second exposure a cos²(x)-intensity distribution is absorbed in the resist. The resulting total intensity distribution does not include a modulation. To the contrary, when using a two photon resist, e.g. a sin⁴(x)-shaped intensity distribution is absorbed during the first exposure, and during the second exposure a cos⁴(x)-shaped intensity distribution is absorbed. The entire intensity absorbed by two photon resist thus has the distribution sin⁴(x)+cos⁴(x). This total intensity distribution is not constant over the location, but it has modulations with twice the spatial frequency of a single interference pattern in the wafer plane. When the resistive sensitivity is adapted to the irradiation dosage accordingly, thus wafer structures with the described double spatial frequency can be generated without an additional development step between the two exposures. In an alternative use of a one photon resist it can be advantageous to perform a chemical development after the first exposure, and to perform the second exposure thereafter through the offset interference pattern.

In some embodiments of the method, described above, at least one portion of the object is exposed multiple times by generating the interference pattern in a first position in the mask plane through a first exposure, and at least partially imaging it onto the object, and through generating the interference pattern in a second position, offset relative to the first position in the mask plane, in a second exposure, and at least partially imaging it onto the object. Furthermore, it can be advantageous to coat the object with a radiation sensitive medium, in particular a resist, before exposures, and to chemically develop the radiation sensitive medium between the first exposure and the second exposure. In a chemical development of the radiation sensitive medium, portions of the medium are removed, which were either sufficiently irradiated during the preceding exposure, or alternatively, portions of the medium can also be removed, which were not sufficiently irradiated during the preceding exposure. In the present case, it can be advantageous to remove the exposed resist components after the first exposure to perform a second exposure with accordingly moved interference pattern thereafter, and to perform a second development step thereafter.

Furthermore, it can be advantageous, to coat the object, or the wafer before the exposures with a two photon resist. As already previously described, in this case, a chemical development step between two exposures can be omitted, whereby the throughput of the microlithography projection exposure system can be increased.

Furthermore, it can be advantageous for the object to be moved continuously in the wafer plane while imaging at least a portion of the interference pattern onto the object, thus during the exposure of the object, to move the image of the interference pattern in the mask plane simultaneously, so that the image of the interference pattern in the wafer plane follows the motion of the object.

The features described with respect to the previously described embodiments of the illumination device, or the microlithography projection exposure system can be transferred accordingly to the method and vice versa. The resulting embodiments of the method resulting there from shall be explicitly included herein.

### BRIEF DESCRIPTION OF THE FIGURES

Microlithography projection exposure systems are described with reference to the appended schematic drawings, showing in:

FIG. 1 is a schematic cut view of a microlithography projection exposure system;

FIG. 2 is a schematic side view for visualizing the principle for generating an interference pattern in the mask plane of the microlithography projection exposure system;

FIG. 3 is an illustration of a dissection of a target structure, to be generated on the wafer, into single partial structures, which can be generated through single exposures;

FIG. 4 is a visualization of the generation of the single partial structures in the mask plane through structured mask illumination;

FIG. 5 is an illustration of the microlithography projection exposure system in the form of a scanner;

FIG. 6 is an illustration of a portion of the illumination optics of a microlithography projection exposure system;

FIG. 7 is an illustration of a single wave generation element configured as a diffractive beam splitter;

FIG. 8 is an illustration of an intensity distribution generated through the microlithography projection exposure system in a two photon resist through double exposure.

### DETAILED DESCRIPTION

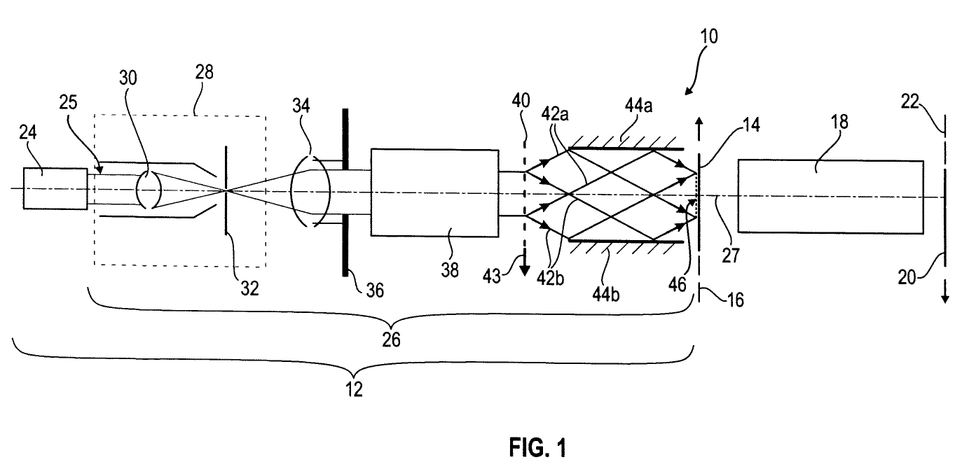

FIG. 1 shows a microlithography projection exposure system 10 that includes an illumination device 12 and projection optics 18 for imaging structures from a mask plane 16 into a wafer plane 22. The illumination device 12 is used for generating an interference pattern in the mask plane 16. Furthermore, the microlithography projection exposure system 10 includes a reticle stage, through which a mask 14 can be disposed in the mask plane 16, when required. Furthermore, a wafer stage for disposing an object shaped as a wafer 20 is provided in the wafer plane 22. The illumination device 12 includes a radiation source 24 in the form of a laser for generating electromagnetic radiation 25, e.g. UV radiation, in the 193 nm wave length range.

The electromagnetic radiation 25 propagates along an optical axis 27 of the microlithography projection exposure system 10. The optical axis 27 coincides with the optical axis of the projection optics 18. After leaving the radiation source 24, the electromagnetic radiation 25 enters into illumination optics 26. In the illumination optics 26, an electromagnetic radiation 25 initially passes through a spatial filter 28, including a focusing lens 30, and a pinhole or a hole aperture 32. Thereafter, the radiation 25 is directed from a collimator 34 to an aperture 36. The aperture 36 can also be provided as so-called rema aperture and can have several aperture elements. A field area is defined through the aperture 36, which is illuminated through the electromagnetic radiation 25 in the mask plane 16.

An imaging objective 38 follows after the aperture 36 in the beam path, wherein the imaging lens can be provided as so-called rema objective. The imaging objective 38 images the aperture 36 onto a single wave generation element 40. The single wave generation element 40 is provided in the form of a beam splitter and provided as a diffractive beam splitter in the shown embodiment. The beam splitter can alternatively also be provided as a conventional beam splitter.

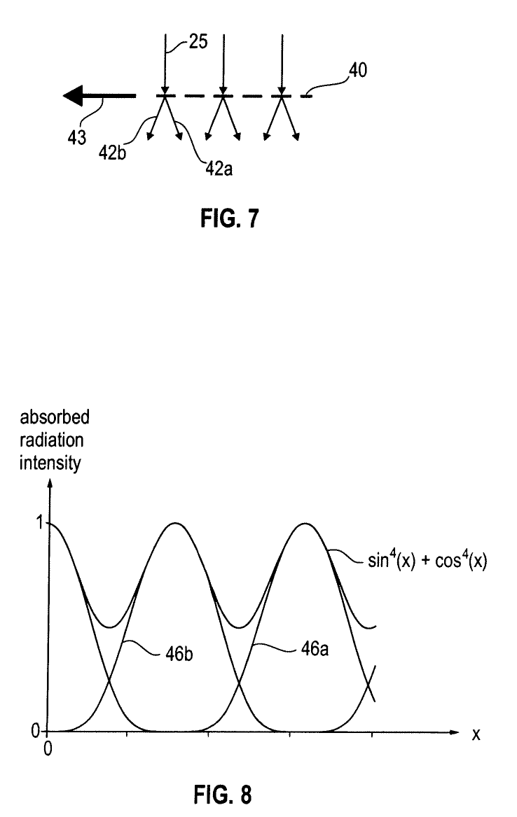

In FIG. 7, the principle of such diffractive beam splitter is illustrated. The beam splitter includes a linear grating. The incoming electromagnetic radiation 25 is split through the grating into different refractive orders. Thus, the resulting refractive orders +1 and −1 are subsequently designated as single waves 42a and 42b, and are processed further in the illumination optics 26. Through the translatoric movement of the beam splitter 40 along a translatoric direction 43 transversal to the optical axis 27, the relative phase difference between the single waves 42a and 42b can be moved. The single waves 42a and 42b impact, as furthermore shown in FIG. 1, the reflection elements 44a or 44b formed as mirrors. The reflection elements 44a and 44b are adjusted so that the single waves 42a and 42b superimpose in the mask plane 16, forming an interference pattern 46 in the shape of a standing wave. Optionally, as described above, furthermore a mask 14 can be disposed in the mask plane 16. The interference pattern 46, or portions of the interference pattern 46, which are passed through by the mask 14, are imaged onto the wafer 20 by the projection optics.

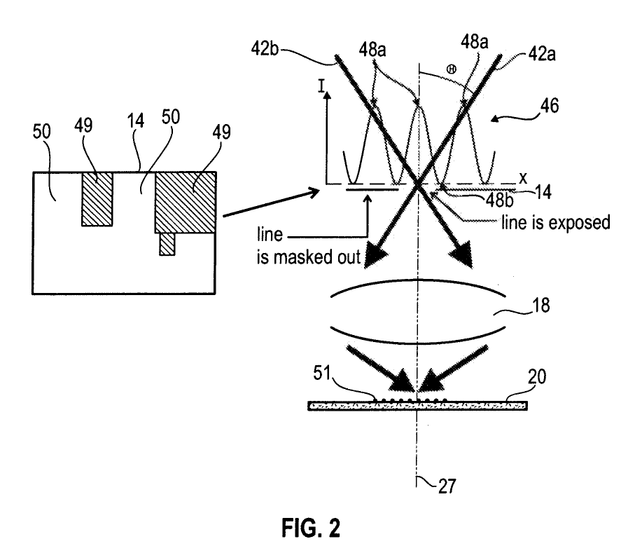

In FIG. 2, the method of wafer exposure using an additional mask 14 is illustrated in more detail. The interference pattern 46 formed as a standing wave is generated on the mask 14. The mask 14 includes radiation permeable mask structures 49, which are shown in FIG. 2 with cross hatch and radiation permeable mask structures 50. In the disposition of the interference pattern 46, relative to the mask 14, shown in FIG. 2, a mean intensity maximum 48a is passed through the mask 14, while both adjacent intensity maxima 48a of the interference pattern 46 are blocked by the mask 14.

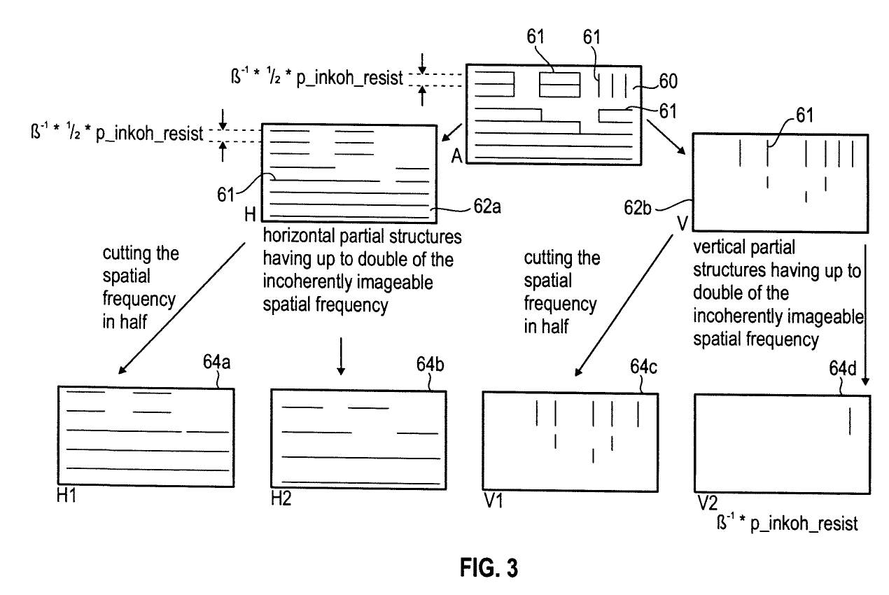

In FIG. 3, a target structural pattern 60 is depicted, which is to be generated on the wafer 20. The single partial structures 61 included therein, either include horizontal, or vertical orientation. The target structure pattern 60 is to be understood as a fictitious mask and includes the structures to be imaged onto the wafer 20 with dimensions adapted to the mask plane. The target structural pattern 60 is thus enlarged relative to the pattern generated in the wafer plane 22 by the inverse imaging scale β⁻¹ of the projection optics 18. The minimum distance between the structures of the target structural pattern 60 is calculated from half of the multiple of β⁻¹ and the stripe distance printable in the wafer plane 22 through the projection optics 18. This means, the distance between the single partial structures 61 in the target structural pattern 60 is half the size, which can be imaged by the projection optics 18. The target structural pattern 60 is initially broken down into two first partial structural patterns 62a and 62b, one of which has all the horizontal partial structures 61 of the structural target pattern 60, and the other one has all the vertical partial structures 61 of the structural target pattern 60. Thereafter, the two first target structural patterns 62a and 62b are divided into two additional second partial structural patterns 64a and 64b, or 64c and 64d respectively. The second partial structural patterns 64a, 64b, 64c, and 64d, each have a doubled minimum distance, compared to the first partial structural patterns 62a and 62b. Thus, each of the second partial structural patterns 64a and 64b includes a set of partial structures 61, having at least the distance from each other, which can be imaged via the projection optics 18. The second partial structural patterns 64a, 64b, 64c, and 64d thus form structural patterns, which can be imaged onto the wafer 20 through single exposures. Thus, the target structural pattern 60 can be generated on the wafer 20 in the respective dimension through multiple exposures.

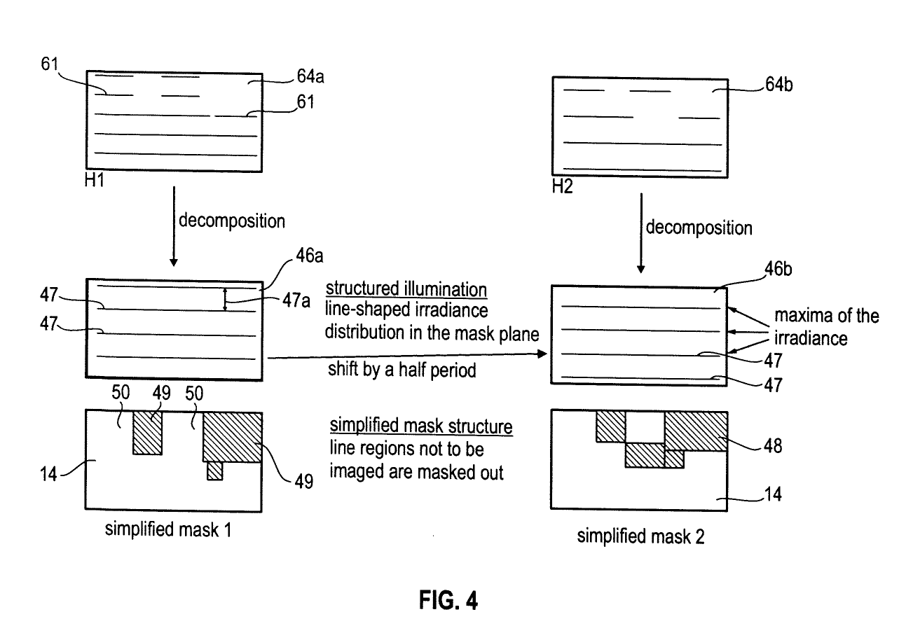

FIG. 4 again shows the second partial structural patterns 64a and 64b again, which are achieved through dividing the only horizontally oriented partial structures 61 in the form of the first partial structural pattern 62a, including lines. The left section of FIG. 4 shows a method of generating the partial structural pattern 64a through irradiation of a mask 14 with the interference pattern 46a disposed in a first position is shown. The mask 14 includes light impermeable mask structures 49 for blocking components of the irradiated light. The requirements with respect to the precision and tolerances of the mask 14 are reduced, compared to a conventional imaging of a mask with an even irradiation strength distribution. The mask 14 is thus designated as a simplified mask in FIG. 4.

The partial structural pattern 64a is thus imaged onto the wafer in a first exposure with the interference pattern 46 disposed in a first position 46a. Thereafter, the interference pattern 46 is moved into a second position 46b. In the second position 46b the stripes 47 of the interference pattern 46 are moved relative to a first position 46a by a half stripe period 47a of the interference pattern 46. For generating the partial structural pattern 64b in the illustrated case, a second mask 14 is exposed with the interference pattern 46b. But it is also possible to perform the second exposure with the interference pattern 46 moved into the second position 46b in connection with the same mask, as in the first exposure. In further exposure steps, then also the partial structural patterns 64c and 64d can be imaged onto the wafer 20. For this purpose the interference pattern 46 is rotated by 90°, and also projected into two different positions in the mask plane 16.

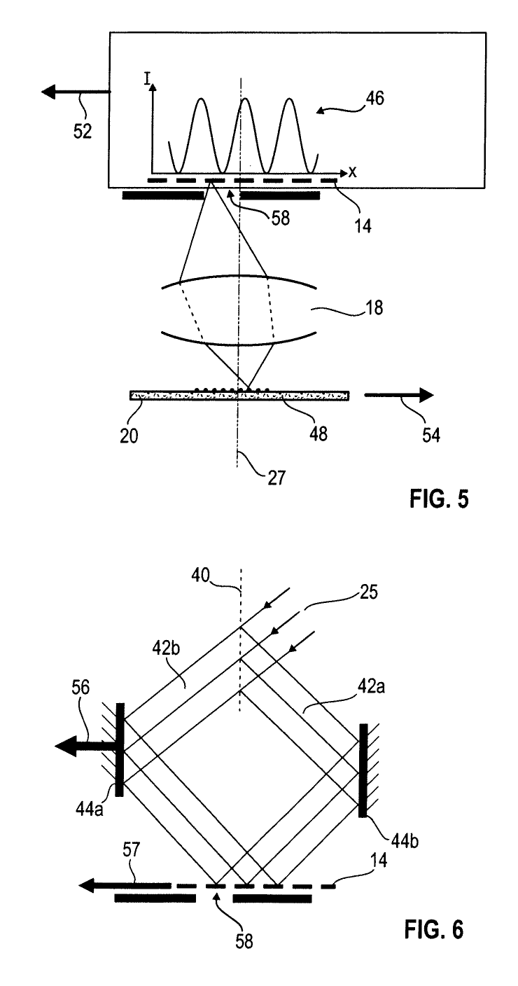

In FIG. 5, the operation of a microlithography projection exposure system 10 in the form of a scanner is shown. In a scanner, the wafer 20 is moved on a wafer stage during the exposure in a scan movement direction 54 transversal to the optical axis 27 of the projection optics 18. Simultaneously, the mask 14 is moved through a reticle stage in a scan movement direction 52 opposite to the scan movement direction 54 of the wafer. Below the mask plane 14 there is a so-called scanner slot, disposed in a fixed location. During the exposure only a section of the mask 14 is imaged through the scanner slot 58 onto the wafer 20. The interference pattern 46 is moved during the exposure of the wafer 20 synchronously with the reticle stage, so that the interference pattern 46 does not move with respect to the mask 14, when a mask 14 is used.

FIG. 6 shows an embodiment of the illumination optical system 26 of the illumination device 12, which is configured to move the interference pattern 46 continuously during exposure. For this purpose, the reflection element 44a is moved in a movement direction 56, parallel to the scan movement direction 52 of the mask. This causes a movement of the interference pattern 14 in a movement direction 57, aligned in parallel to the scan movement direction 52. Other alternatives for moving the interference pattern 56 during the exposure include a relative translatoric movement between the illumination optics 26 and the projection optics 18.

Optionally, the wafer 20 is coated with a two photon resist. Such a two photon resist includes molecules, whose energy level is adapted to be excited through the absorption of two irradiated photons of the illumination wave length. FIG. 8 shows a distribution of a radiation intensity absorbed through the double exposure in a two photon resist. Only the absorbed photons are chemically effective in the resist. The intensity distribution absorbed through the interference pattern 46 in the first position 46a in the two photon resist follows the function cos⁴(x) along a location coordinate in the mask plane. The intensity distribution absorbed through the interference pattern 46 in the second position 46b in the two photon resist follows the function sin⁴(x). The superposition of the two intensity distributions follows the function sin⁴(x)+cos⁴(x) and includes a modulation in the direction of the local coordinate, which is sufficient to structure the resist. When using such two photon resist, a chemical development step between a first exposure and a second exposure of the wafer is not necessary. In an alternative embodiment, the wafer is coated with a two photon resist. In this case, the resist is chemically developed between a first exposure and a second exposure.

Other embodiments are in the claims.

What is claimed is:

1. An illumination device, comprising:
a radiation source configured to generate electromagnetic radiation; and
illumination optics configured to direct the electromagnetic radiation onto the mask plane,
wherein:
the illumination system has a mask plane where the mask, when present, is located;
the illumination device is configured to generate an interference pattern in the mask plane; and
the illumination device is configured to be used in a microlithography projection exposure system.

2. The illumination device according to claim 1, wherein the illumination device is configured to generate at least two single waves, which are coherent to each other, and to generate the interference pattern via superposition of the single waves in the mask plane.

3. The illumination device according to claim 2, wherein the illumination optics comprise:
a generation element configured to generate single waves; and
at least one reflection element,
wherein the generation element splits the electromagnetic radiation into the two single waves, and the reflection element redirects one of the single waves, so that the two single waves generate the interference pattern via superposition in the mask plane during the operation of the illumination device.

4. The illumination device according to claim 2, wherein the illumination device is configured to move the interference pattern from a first position to a second position in the mask plane by changing the relative phase of the single waves.

5. The illumination device according to claim 3, wherein the reflection element is movable, so that the relative phase of the single waves can be changed by moving the reflection element.

6. The illumination device according to claim 3, wherein the single wave generation element is configured as a diffractive beam splitter that is movable so as to change the relative phase of the single waves.

7. The illumination device according to claim 3, wherein the illumination optics comprise at least one aperture for defining an illuminated portion in the mask plane, and the aperture is disposed in the beam path of the illumination optics in front of the generation element.

8. The illumination device according to claim 1, wherein:
the illumination device is configured for operation in a microlithography projection illumination system;
the illumination device is provided as a scanner, in which an exposed object is moved in a wafer plane of the microlithography projection exposure system continuously during exposure; and
the illumination device is configured to move the interference pattern in the mask plane during the exposure of the object, so that the image of the interference pattern in the wafer plane follows the movement of the object.

9. The illumination device according to claim 1, wherein an interference pattern generated by the illumination device comprises a stripe pattern comprising straight stripes, which are disposed periodically with the rims of the stripes extending respectively along a straight line, and wherein the maximum deviation of the rims from the respective straight line is less than a twentieth of the stripe period.

10. The illumination device according to claim 1, wherein the illumination device is provided to generate an interference pattern in different orientations in the mask plane.

11. A mask, comprising:
at least one mask structure configured to generate a target structure in a radiation sensitive medium,
wherein the mask is configured to be used in a microlithography projection illumination system, and the shape of the mask structure differs from the shape of a target structure so that the target structure can be generated in the radiation sensitive medium via illumination of the mask through variable illumination in the mask plane.

12. The mask according to claim 11, wherein the target structure can be generated in the radiation sensitive medium via illumination of the mask through an interference pattern generated with an illumination device according to claim 1.

13. An optical system having a mask plane and an object plane, the optical system, comprising:
an illumination device according to claim 1 configured to generate an interference pattern in the mask plane; and
projection optics configured to image at least a portion of the interference pattern from the mask plane into the wafer plane,
wherein the optical system is a microlithography projection exposure system.

14. The optical system according to claim 13, wherein, during use, the microlithography projection exposure system is configured to expose at least a portion of the object at least first and second times, the interference pattern is disposed in a first position in the mask plane during the first exposure, and the interference pattern is disposed in a second position during the second exposure, and the second position is offset relative to the first position in the mask plane.

15. The optical system according to claim 14, wherein, during use, the interference pattern has periodically occurring intensity maxima and the first position of the interference pattern is offset relative to the second position of the interference pattern by at least one quarter of the stripe period of the interference pattern in the mask plane.

16. The optical system according to claim 14, wherein the projection optics are configured for operation with electromagnetic radiation in a certain wave length range, and thereby has a resolution limit for imaging an even stripe pattern from the mask plane into the wafer plane, wherein a minimum distance between adjacent stripes of a stripe pattern, which can still be imaged by the projection optics, is defined through the resolution limit, and wherein the first position of the interference pattern is offset relative to the second position of the interference pattern by less than the minimum distance.

17. The optical system according to claim 13, wherein the projection optics have an optical axis, and the illumination optics and the projection optics are movable relative to each other in a direction transverse to the optical axis.

18. The optical system according to claim 13, wherein the microlithography projection exposure system is a scanner, the microlithography projection exposure system has a wafer stage for continuous movement of an object in the wafer plane during the exposure, and the microlithography projection exposure system is configured to move the interference pattern in the mask plane during the exposure of the object so that the imaging of the interference pattern in the wafer plane follows the movement of the object.

19. The optical system according to claim 18, wherein the optical system comprises a reticle stage for continuous movement of a mask in the mask plane with a movement coupled to the movement of the wafer stage, and the illumination device is configured to displace the interference pattern in the mask plane synchronously with the movement of the reticle stage during the exposure of the object.

20. The optical system according to claim 13, further a mask according to claim 11 disposed in the mask plane.

21. The optical system according to claim 13, further comprising an object in the wafer plane, the object comprising a two-photon-resist coating.

22. A method, comprising:
providing a microlithography projection exposure system having a mask plane, a wafer plane, the microlithography projection exposure system comprising an illumination device configured to illuminate the mask plane with electromagnetic radiation, an object in the wafer plane, and projection optics configured to image an object structure from the mask plane into the wafer plane;
generating an interference pattern in the mask plane via the illumination device; and
imaging at least a portion of the interference pattern via the projection optics onto the object.

23. The method according to claim 22, wherein the method comprises generating a first interference pattern in a first position in the mask plane in a first exposure to at least partially imaging the mask onto the object, and generating a second interference pattern in a second position in a second exposure to at least partially image the mask onto the object, the second position being offset in the mask plane relative to the first position.

24. The method according to claim 23, wherein the object is coated with a radiation sensitive medium before the first exposure, and the radiation sensitive medium is chemically developed between the first exposure and the second exposure.

25. The method according to claim 22, wherein the object is continuously moved in the wafer plane during the imaging of at least portion of the interference pattern onto the object, and simultaneously the interference pattern is moved in the mask plane, so that the image of the interference pattern in the wafer plane follows the movement of the object.
